(19) United States
(12) Patent Application Publication
(10) Pub. No.: US 2004/0139710 A1
(43) Pub. Date: Jul. 22, 2004

(54) Passive transfer chamber separator

(76) Inventors: Lewis Illingworth, Kensington, NH (US); David Reinfeld, Englewood, NJ (US)

Correspondence Address: John W. Olivo, Jr., Esq., WARD & OLIVO, Suite 300, 382 Springfield Avenue, Summit, NJ, 07901, US

(21) Appl. No.: 10/681,036

(22) Filed: Oct. 8, 2003

Related U.S. Application Data
(63) Continuation-in-part of application No. 10/318,320, filed on Dec. 12, 2002.
Application No. 10/318,320 is a continuation-in-part of application No. 10/025,376, filed on Dec. 19, 2001, now Pat. No. 6,719,830.
Application No. 10/025,376 is a continuation-in-part of application No. 09/835,084, filed on Apr. 13, 2001, now Pat. No. 6,687,951.
Application No. 09/835,084 is a continuation-in-part of application No. 09/829,416, filed on Apr. 9, 2001, now Pat. No. 6,729,839.
Application No. 09/829,416 is a continuation-in-part of application No. 09/728,602, filed on Dec. 1, 2000, now Pat. No. 6,616,094.
Application No. 09/728,602 is a continuation-in-part of application No. 09/316,318, filed on May 21, 1999, now Pat. No. 6,595,753.

(51) Int. Cl. B01D 45/00

(52) U.S. Cl. 55/406; 55/459.1

(57) ABSTRACT

The present invention is a design for a highly efficient passive separator. The invention utilizes passive air rotation techniques in combination with centrifugal separation and a particulate reservoir to achieve highly efficient, highly effective separation of, e.g., particulate matter from a fluid.

### CROSS REFERENCE TO OTHER APPLICATIONS

This application is filed as a continuation-in-part of co-pending application Ser. No. 10/318,320 entitled “Axial Flow Centrifugal Dust Separator,” filed Dec. 12, 2002 which is a continuation-in-part of co-pending application Ser. No. 10/025,376 entitled “Toroidal Vortex Vacuum Cleaner Centrifugal Dust Separator,” filed Dec. 19, 2001, which is a continuation-in-part of allowed application Ser. No. 09/835,084 entitled “Toroidal Vortex Bagless Vacuum Cleaner,” filed Apr. 13, 2001, which is a continuation-in-part of allowed application Ser. No. 09/829,416 entitled “Toroidal and Compound Vortex Attractor,” filed Apr. 9, 2001, which is a continuation-in-part of U.S. Pat. No. 6,616,094, filed Dec. 1, 2000, entitled “Lifting Platform,” which is a continuation-in-part of U.S. Pat. No. 6,595,753, filed May 21, 1999, entitled “Vortex Attractor,” all of which are hereby incorporated herein by reference.

### TECHNICAL FIELD OF THE INVENTION

The present invention relates generally to an improved separator for separating, e.g., dust from a fluid flow. More specifically, the present invention relates to an improved separator utilizing passive air rotation techniques in conjunction with a transfer slot to achieve highly efficient separation.

### BACKGROUND OF THE INVENTION

The inventor is aware of certain existing technology that will facilitate understanding of the novel subject matter of the present invention.

FIGS. 1A and 1B (PRIOR ART) depict a typical dynamic transfer dust separator 100. Looking at the side view, shown in FIG. 1A, dusty air (or any type of fluid having some concentration of higher density matter) is drawn into the input pipe 103. As it passes point A, it moves through the blades 106 of a centrifugal impeller 104 powered by motor 107. Air 105, leaving the blades 106 at point B, moves from left to right while following a spiral path until it reaches point C. At point C, the air 105 moves inward to enter the exit pipe 111 at point D. Centrifugal forces acting on dust particles in the air 105 spiraling around between the outer casing 102 and the circular inner air guide 110 cause them to migrate out to the inner wall of the outer casing 102. Therefore, the space enclosed by the outer casing 102 comprises a separation chamber 101 with high dust concentrations close to the outer wall and low dust concentrations at the center. When air 105 turns away from the outer wall at C, the dust it contains continues to circulate around the inside of the outer wall. Thus, the air 105 at the center of the chamber as it exits at D via exit pipe 111 is essentially cleaned of dust. The dust travels through a transfer slot 108 and into a dust box 109 for storage. The particulars of the dust box are discussed infra.

FIG. 1B shows a cross-section of the dust separator 100. This view shows air 105 circulating in the separation chamber 101, (i.e., the space between the central air guide 110 and the outer casing 102). Dust migrates to the outside of this circulating airflow to follow a path close to the inner wall of the outer casing 102. A transfer slot 108 in the bottom of this wall allows dust particles to travel (along the path shown by streamline 116) into the lower dust box 109 while air 105 makes the turn to remain in the separation chamber and continues to circulate. After the dust circulates in the dust box 109, it eventually settles at the bottom (as shown by collected dust 115).

When dust enters the dust box 109, the combination of its own energy, air movement, and the friction between air from the separation chamber 101 and the air in the dust box 109 causes the dust in the dust box 109 to continue to circulate. This circulation occurs in the top section of the dust box 109 while the dust rapidly settles to the bottom. The combination of the shape of the transfer slot 108 and the inertia of dust particles in the circulation below it prevents dust in the box 109 from migrating back into the separation chamber 101.

The system 100 also works when the dust box 109 is located on the side of the separation chamber 101. The circulating dusty airflow in the dust box 109 pushes the dust away from the transfer slot to form coagulated dust masses.

FIGS. 2A&B (PRIOR ART) show another existing technology, namely, a typical cyclonic separator. Cyclonic separators generally take the form of a tapered cylinder 205 into which air enters 201 through an input pipe 202 that is set tangentially to the cylinder wall. The air flows around the inside of the cylinder as shown by streamline 203, held there by centrifugal force (centripetal acceleration). As the air flows downward, the dust contained within the air stream is thrown outward to the cylinder wall due to its relatively higher density. The dust slides down the wall where it collects at the bottom of the cylinder 204. Clean air 207, however, is drawn to the center and flows upward through the output pipe 206 leaving the dust behind.

The last relevant technology that the inventor is aware of is swirl tube separation. Swirl tube and cyclonic separators differ in the method of spinning the air around into a spiral path through the separation chamber. The swirl tube method, however, may require less power to move air through the separator.

FIG. 3 shows a typical swirl tube dust separator 300. Dusty air 301 enters the separator 300 via input pipe 302 and is directed downward to pass through a series of curved vanes 303. These vanes 303 impart a tangential velocity component so that the dusty air spirals down the inside of the cylindrical outer casing 305 generally in accordance with streamline 306. As in the cyclonic separator of FIG. 2, dust is thrown to the wall of the separation chamber 304 and it falls down to the bottom 307. Clean air 309 returns to the central output tube 308 and exits upwards.

The preceding technologies are the basis for the novel subject of the present invention, and have been presented to assist the reader's understanding thereof.

### SUMMARY OF THE INVENTION

Although the terms “dust,” “dusty,” “air,” “dusty air,” and the like are used throughout to represent the fluid and particulate with which the invention operates, they should be taken as merely examples of a fluid and associated particulate. The invention is equally adept at separating, e.g., sand from water. Also, the invention is not limited to separating matter of different states (e.g., a solid from a liquid), but could also separate matter of the same state (e.g., two insoluble liquids of different densities).

Generally, transfer chamber dust separators have two distinct dust separation chambers that are coupled together by a transfer slot. In the first chamber, i.e., the separation chamber, dusty air circulates to allow dust to be thrown out to the chamber walls by centrifugal force (centripetal acceleration). Dust then flows through a slot (referred to herein as “transfer slot”) in the separation chamber's outer wall into the second chamber that is frequently called the dust box. Notably, the term “slot” should not be taken to require any specific geometry or configuration, but merely an opening or coupling that allows the transport of particulates. Dust circulates around in the dust box in a way that its inertia prevents it from being caught up by the clean airflow leaving the separation chamber. This secondary dust circulation is by no means essential to the operation but is very effective in retaining the finest of dust particles and also low density particles.

The separators of the present invention do not require a centrifugal air pump impeller but instead achieve appropriate airflow by employing passive techniques as used in, e.g., swirl tube and cyclonic separators. These passive features are combined with a separator chamber to increase efficiency. Thus, these novel separators can be characterized as “Passive Transfer Chamber Dust Separators.” The separation system is provided with circulating air either by injecting air tangentially into the separation chamber (as in a cyclonic separator) or by moving the air through a series of curved vanes (as in a swirl tube separator). The performance is superior to that of conventional separators because the transfer chamber system prevents particulates separated out to be drawn back into the air stream. When applied to these passive techniques, the transfer chamber approach significantly improves the amount of fine and low density dust that can be captured by separating it from the airflow through a dust separator system.

In accordance with the present invention, two embodiments of passive separators are described that have separation and particulate collecting chambers connected by a transfer slot. Circulation in the separation chamber throws particulates out to the chamber wall by centrifugal force. From there, it passes through the transfer slot to the particulate box. Particulates continue to circulate in the particulate box and are prevented from re-entering the separation chamber by their own inertia.

Thus, it is an object of the present invention to provide an efficient separator.

It is another object of the present invention to provide an efficient separator for separating dust from air.

Additionally, it is an object of the present invention to provide an efficient separator for separating particulates from air.

Furthermore, it is an object of the present invention to efficiently separate particulates from a fluid.

It is yet another object of the present invention to separate two fluids.

It is an additional object of the present invention to combine a separation chamber with passive air steering techniques.

These and other objects will become readily apparent to one skilled in the art upon review of the following description, figures, and claims.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIGS. 1A and 1B (PRIOR ART), already discussed, depict a typical dynamic transfer dust separator;

FIG. 2 (PRIOR ART), already discussed, depicts a typical cyclonic separator;

FIG. 3 (PRIOR ART), already discussed, depicts a typical swirl tube dust separator;

FIGS. 4A, 4B, and 4C depict a cyclonic transfer chamber dust separator in accordance with the present invention; and

FIGS. 5A and 5B depict swirl tube transfer chamber dust separator in accordance with the present invention.

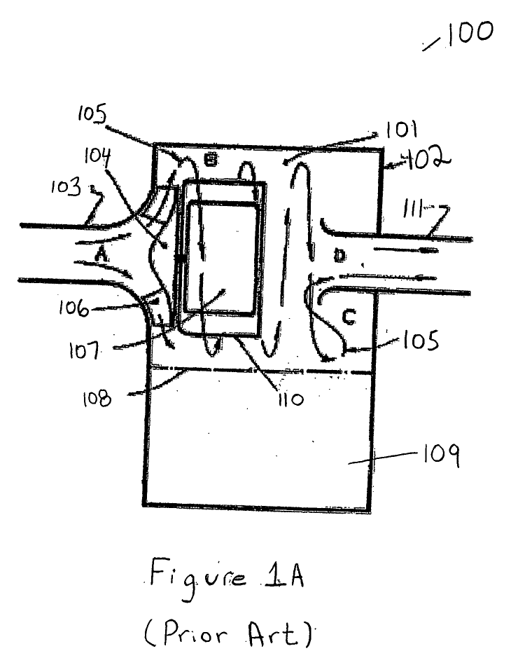

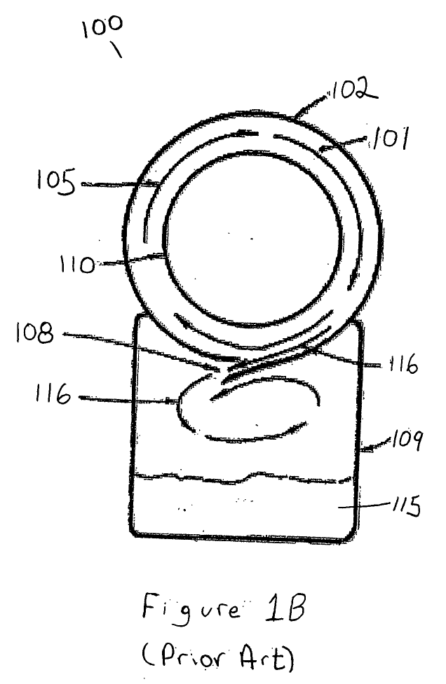

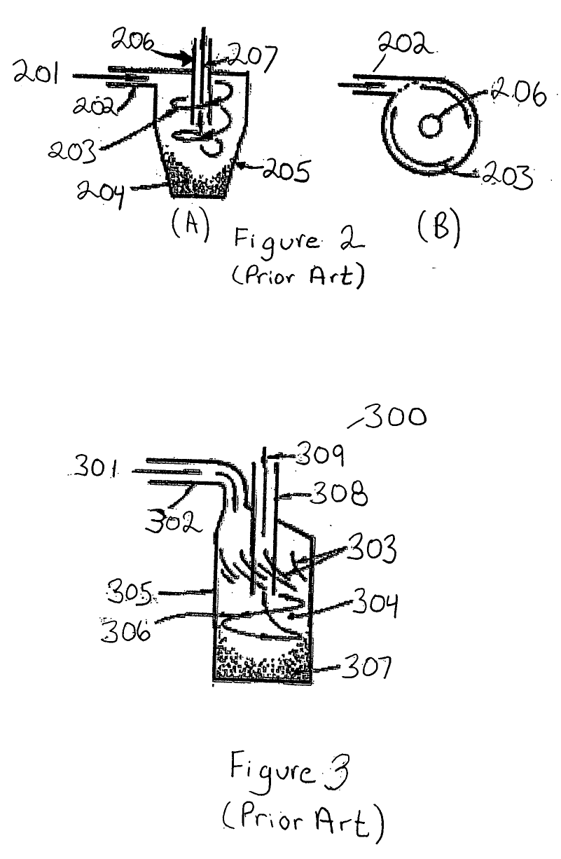

### DETAILED DESCRIPTION OF THE PREFERRED EMBODIMENTS

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention and features thereof.

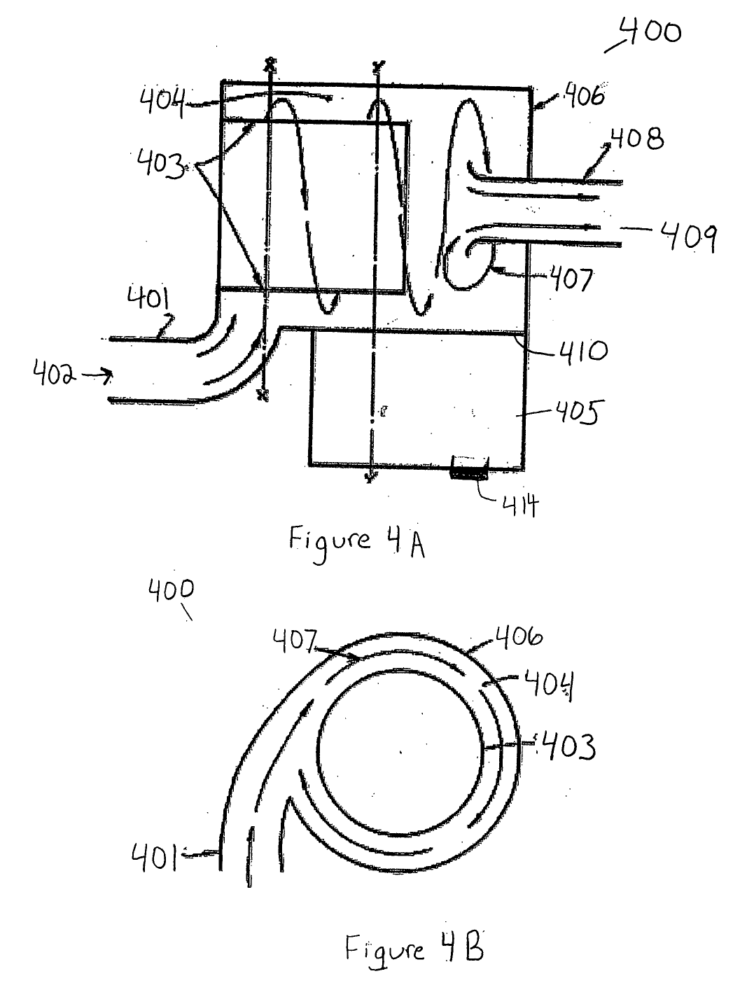

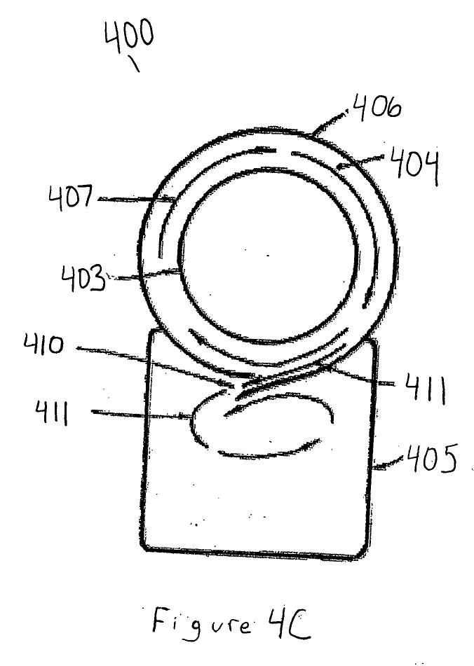

Referring to FIG. 4A, the cyclonic transfer chamber separator 400 uses an input system that produces an air stream 407 circulating around the inside of a cylindrical separation chamber 404 but adds a separate dust box 405 connected by a transfer slot 410. Dirty air is piped in 402 at the bottom left via input pipe 401. The dirty air circulates around the central air guide 403. Centrifugal force ensures that particulate matter is forced outward toward the inside surface of the outer casing 406. The density of the particulate matter forces it to eventually pass through the transfer slot 410 and deposit in the dust box 405. Because of its comparatively small density, clean air 409 is able to make its way out of the separator 400 via output pipe 408. The user can empty the stored particulate matter by utilizing opening 414. Opening 414 may take the form, e.g., of a hole with a plug, a threaded stem and cap, or any other type of resealable opening. Alternatively, a bag (e.g., flexible plastic) may be used in place of dust box 405. When air is blown into the dust box 405, it is above atmospheric. Thus, if a bag is used, it will inflate due to the internal pressure being greater than external. When the bag becomes full of dust, it can be removed, sealed, and discarded. Notably, many other passive dust separators draw air through the system via the output pipe 408. Thus, the pressure in the dust box would below atmospheric and would not allow use of a flexible bag.

The cyclonic system 400 requires a 900 direction change in airflow from input 402 to output 409. FIG. 4A shows air entering horizontally, and turned upwards to enter the separation chamber 404. The 90° bend is shown for convenience to maintain a horizontal input to output airflow. The bend is not a necessary feature of the invention, but can be implemented depending upon application. Also, the system 400 can be mounted in any direction because transfer slot operation does not rely on gravity. When mounted at 90° to the direction of FIG. 4A, dust will fall to what is then the bottom.

FIG. 4B illustrates the cross-section at X-X in FIG. 4A. The illustration shows that dirty air enters input pipe 401 tangentially to a circular dust separation chamber 404 around which the air flow 407 takes on a spiral path. Notably, the central air guide 403 defines the inside of the separation chamber 404. Returning back to FIG. 4A, the spiral path of the airflow 407 moves from left to right.

The cross-section Y-Y of FIG. 4A is shown in FIG. 4C. This view shows air (or other fluid) 407 circulating in the separation chamber 404, i.e., the space between the central air guide 403 and the outer casing 406. Centrifugal acceleration mandates that particulates (or any suspended matter with greater density than the fluid in which it is disposed) migrate to the outside of this circulating airflow to follow a path close to the inner wall of the outer casing 406. A transfer slot 410 in the bottom of this wall allows particulates to travel (along path shown by streamline 411) into the lower particulate box 405 while air 407 remains in the separation chamber 404 and continues to circulate. After the particulates circulate in the particulate box 405, they eventually settle at the bottom.

When particulates enter the particulate box 405, the combination of their own energy and air movement coupled by friction between air from the separation chamber 404 and air in the dust box 405 causes the particulates in the particulate box 405 to continue to circulate. This circulation occurs in the top section of the particulate box 405 while the particulates rapidly settle to the bottom. The combination of the shape of the transfer slot 410 and the inertia of particulates in the circulation below it prevents particulates in the box 405 from migrating back into the separation chamber 404.

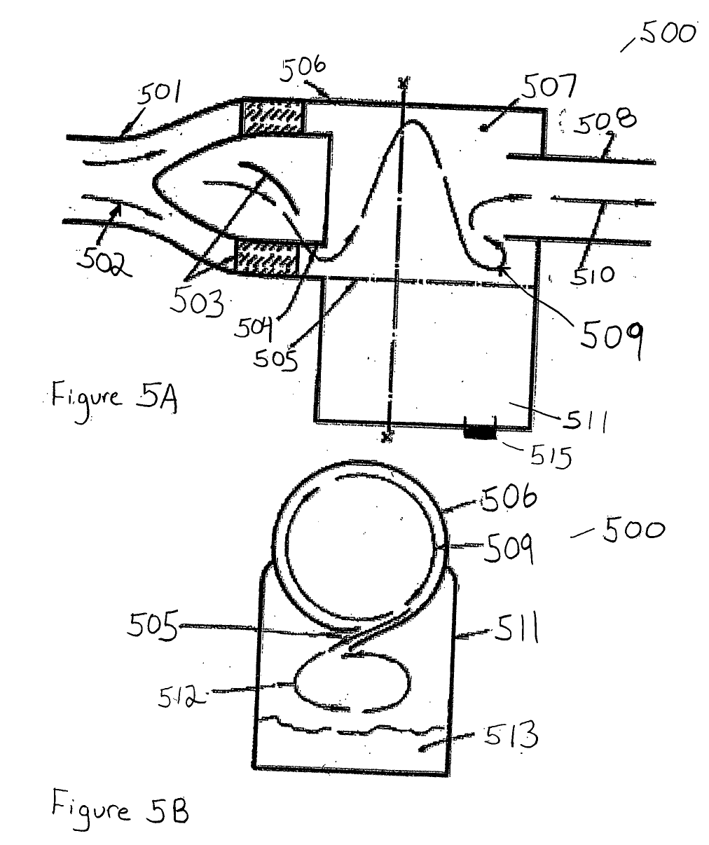

FIGS. 5A and 5B show a transfer chamber dust separator 500 utilizing a swirl tube approach. Referring to the side view in FIG. 5A, air having particulate matter dispersed therein enters 502 via the input pipe 501 and passes around a central air guide 504. The input pipe diameter expands to become the outer casing 506 of the separation chamber 507. The space between the central air guide 504 and the outer casing 506 forms an annulus. Within the annulus, a series of curved blades (i.e., swirl vanes) 503 mounted around the central air guide 504 cause the airflow 509 to spiral inside the separation chamber 507. The arrangement of the curved blades is such that sufficient spin is imparted to the airflow to allow ejection of higher-density matter. The rotation of air flow 509 causes the particulate matter to be ejected outward toward the walls of the outer casing 506. Eventually, the particulate matter will be ejected from the airflow 509 and pass through the transfer slot 505 into the particulate box 511. Since the density of the air is comparatively small, it is able to exit the separation chamber 510 via output pipe 508, cleaned of particulate matter. The user can empty the stored particulate matter by utilizing opening 515. Opening 515 may take the form, e.g., of a hole with a plug, a threaded stem and cap, or any other type of resealable opening. Alternatively, a bag (e.g., flexible plastic) may be used in place of particulate box 511. When air, e.g., is blown into the dust box 511, it is above atmospheric. Thus, if a bag is used, it will inflate due to the internal pressure being greater than external. When the bag becomes full of dust, it can be removed, sealed, and discarded. Notably, many other passive dust separators draw air through the system via the output pipe 508. Thus, the pressure in the dust box would below atmospheric and would not allow use of a flexible bag.

The cross-section X-X of FIG. 5A is shown in FIG. 5B. Air and particulate matter circulate 509 around the inside of the separation chamber wall. The air and particulate matter spin due to swirl vanes 503 (not visible in this view). The particulate matter, due to centrifugal force, will pass through transfer slot 505 into the particulate box 511, where it will collect into a pile 513. The system 500 can be mounted in any direction because transfer slot operation does not rely on gravity. When mounted at 90° to the direction of FIG. 5A, dust will fall to what is then the bottom.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

We claim:

1. A highly efficient, passive separator for separating matter from a fluid flow comprising:
input means for receiving said fluid flow;
passive guiding means coupled to said input means for guiding said fluid flow into a rotating flow, said rotating flow causing a centrifugal force to force said matter in a direction tangentially outward from said rotating flow;
transfer means coupled to a storage means for capturing said matter centrifugally forced in a direction tangentially outward from said rotating flow and guiding said matter into said storage means, wherein said storage means prevents said matter from reentering said rotating fluid flow;
output means for allowing said rotating fluid flow to escape said separator, wherein said escaped rotating fluid flow comprises a lesser concentration of said matter than in said fluid flow.

2. A separator in accordance with claim 1, wherein said input means is in the form of a pipe.

3. A separator in accordance with claim 1, wherein said input means is in the form of a pipe having a ninety-degree bend.

4. A separator in accordance with claim 1, wherein said passive guiding means comprises:
a cylinder coupled perpendicularly to said input means.

5. A separator in accordance with claim 1, wherein said passive guiding means comprises:
a cylinder wherein said fluid flow rotates around said cylinder thereby creating said rotating fluid flow.

6. A separator in accordance with claim 1, wherein said passive guiding means comprises:
a central air guide disposed within said input means, the space between said central air guide and said input means forming a cavity; and
at least one curved vane disposed on said central air guide such that as said fluid flows through said cavity, it becomes said rotating fluid flow.

7. A separator in accordance with claim 2, wherein said passive guiding means comprises:
a central air guide disposed within said input means, the space between said central air guide and said input means forming an annulus; and
at least one curved vane disposed on said central air guide such that as said fluid flows through said annulus, it becomes said rotating fluid flow.

8. A separator in accordance with claim 1 wherein said transfer means is a slot.

9. A separator in accordance with claim 1 wherein said transfer means is an opening such that said matter centrifugally forced in a direction tangentially outward from said rotating fluid flow can pass therethrough.

10. A separator in accordance with claim 1 wherein said storage means is a box.

11. A separator in accordance with claim 1, wherein said storage means further comprises an opening.

12. A separator in accordance with claim 1, wherein said storage means further comprises an opening for emptying said matter stored in said storage means.

13. A separator in accordance with claim 1, wherein said output means comprises a pipe.

14. A separator in accordance with claim 1, wherein said fluid flow comprises air.

15. A separator in accordance with claim 1, wherein said fluid flow comprises a gas.

16. A separator in accordance with claim 1, wherein said fluid flow comprises water.

17. A separator in accordance with claim 1, wherein said fluid flow comprises a liquid.

18. A separator in accordance with claim 1, wherein said matter is dust.

19. A separator in accordance with claim 1, wherein said matter is in solid form.

20. A separator in accordance with claim 1, wherein said matter is a liquid.

21. An efficient, passive separator utilizing cyclonic separation, said separator comprising:
an input pipe for receiving a fluid flow having a concentration of particulates;
a cylinder enclosed within a housing, wherein said input pipe is coupled to said housing and further wherein said fluid flow is tangential to the lateral sides of said cylinder, and further wherein said fluid flows around said lateral sides of said cylinder, thereby becoming a rotating fluid flow;
an opening substantially parallel to the lateral sides of said cylinder;
a container coupled to said opening;
an output pipe coupled to said housing; and
wherein centrifugal force forces at least some of said particulates through said opening and into said container, thereby allowing said rotating fluid flow to escape said output pipe having a substantially reduced concentration of particulates.

22. A separator according to claim 21, wherein said input pipe comprises a substantially ninety degree bend.

23. A separator according to claim 21, wherein said container comprises means to allow emptying particulate matter therefrom.

24. A separator according to claim 23 wherein said means to allow emptying comprises a second opening.

25. A separator according to claim 21 wherein said fluid flow comprises air.

26. A separator according to claim 21 wherein said fluid flow comprises a gas.

27. A separator according to claim 21 wherein said fluid flow comprises water.

28. A separator according to claim 21 wherein said fluid flow comprises a liquid.

29. A separator according to claim 21 wherein said particulates constitute matter in the solid form.

30. A separator according to claim 21 wherein said particulates constitute matter in the liquid form.

31. A separator according to claim 21 wherein said particulates are dust.

32. An efficient, passive separator utilizing swirl tube separation, said separator comprising:
an input tube to receiving a fluid flow having a concentration of particulates;
a housing;
a swirl tube coupled to said input tube and said housing for transforming said fluid flow into a rotating fluid flow;
an opening disposed within said housing substantially tangent to the direction of rotation of said fluid flow;
a container coupled to said opening and said housing, wherein centrifugal force ejects at least some of said particulates from said rotating fluid flow through said opening and into said container;
an output tube coupled to said housing for expelling said rotating fluid flow, wherein said rotating fluid flow has a substantially reduced concentration of particulates.

32. A separator according to claim 31, wherein said swirl tube comprises a central air guide having at least one vane disposed thereon.

33. A separator according to claim 31, wherein said container comprises means to allow emptying particulate matter therefrom.

34. A separator according to claim 33 wherein said means to allow emptying comprises a second opening.

35. A separator according to claim 31 wherein said fluid flow comprises air.

36. A separator according to claim 31 wherein said fluid flow comprises a gas.

37. A separator according to claim 31 wherein said fluid flow comprises water.

38. A separator according to claim 31 wherein said fluid flow comprises a liquid.

39. A separator according to claim 31 wherein said particulates constitute matter in the solid form.

40. A separator according to claim 31 wherein said particulates constitute matter in the liquid form.

41. A separator according to claim 31 wherein said particulates are dust.

42. A separator according to claim 31 wherein said swirl tube comprises:
a bullet-shaped air guide disposed within a pipe, said pipe being coupled to said input pipe; and
at least one vane coupled to said bullet-shaped air guide.

43. A method for separating comprising the steps of:
passively imparting a spin on a fluid flow;
utilizing centrifugal force to separate at least one particulate from said fluid flow; and
capturing said at least one particulate and storing said particulate such that it cannot reenter said fluid flow.

44. A method according to claim 43 wherein said step of passively imparting is performed by a cyclonic separator.

45. A method according to claim 43 wherein said step of passively imparting is performed by a swirl tube.
